(19) United States
(12) Patent Application Publication
(10) Pub. No.: US 2019/0306690 A1
(43) Pub. Date: Oct. 3, 2019

(54) WIRELESS COEXISTENCE USING RADIO ENERGY DETECTION AND CLASSIFICATION

(71) Applicant: QUALCOMM Incorporated, San Diego, CA (US)

(72) Inventors: Sandip HomChaudhuri, San Jose, CA (US); Gangadhar Burra, Fremont, CA (US); Vincent Knowles Jones, IV, Redwood City, CA (US)

(21) Appl. No.: 15/940,923

(22) Filed: Mar. 29, 2018

(51) Int. Cl. H04W 8/00; H04B 17/382; H04W 72/04

(52) U.S. Cl. CPC H04W 8/005; H04B 1/7075; H04W 72/0446; H04B 17/382

(57) ABSTRACT

This disclosure provides systems, methods, and apparatus, including computer programs encoded on computer-readable media, for wireless coexistence. In one aspect, an electronic device may have a first wireless interface associated with a first wireless communication technology (such as a wireless local area network, WLAN, technology). The first wireless interface may use measurements of raw energy detected on a wireless channel to determine that a second wireless communication technology (such as a wide area network, WAN, technology) is being used on the wireless channel by another device. In one aspect, the electronic device does not need to decode the coexisting communication signals to determine time alignment for the second wireless communication technology. The electronic device may modify a transmission schedule for the first wireless communication technology based on the coexisting second wireless communication technology.

### TECHNICAL FIELD

This disclosure relates to the field of network communication, and more particularly to coexistence of wireless communication systems.

### DESCRIPTION OF THE RELATED TECHNOLOGY

There are several types of wireless communication technologies. For example, a wireless local area network (WLAN) may include an access point (AP) and one or more stations (STAs) that can communicate via a wireless channel. The wireless channel may utilize a portion of a frequency band (such as a 2.4 GHz frequency band, a 5 GHz frequency band, a 6 GHz frequency band, etc.). Within each frequency band, there may be different channels and different wireless networks that share the frequency band. New wireless communication technologies are being developed which can utilize overlapping portions of a frequency band. For example, WLAN signals may occupy a frequency band that is also used by signals of another wireless communication technology (such as satellite, radar, terrestrial radio, or cellular signals). It is possible for several wireless communication technologies to be in operation in the same location. Furthermore, it may be desirable to concurrently use more than one wireless communication technology in a same wireless channel.

Coexistence techniques enable more than one wireless communication technology to concurrently utilize a same wireless channel while minimizing cross-technology interference. Typically, a coexistence technique involves the use of a collocated interface to receive and process wireless signals for a coexisting wireless technology. Current coexistence techniques utilize complex hardware designs or cross-technology signaling protocols.

### SUMMARY

The systems, methods, and devices of this disclosure each have several innovative aspects, no single one of which is solely responsible for the desirable attributes disclosed herein.

One innovative aspect of the subject matter described in this disclosure can be implemented as a method, system, computer-readable medium or other means in an electronic device. The electronic device may include a first wireless interface that is associated with a first wireless communication technology. The electronic device may detect radio energy projections on a wireless channel by the first wireless interface of an electronic device. The electronic device may determine a quantity of the radio energy projections that are above a signal strength threshold and that are not attributable to a first wireless communication technology associated with the first wireless interface. The electronic device may determine, by the first wireless interface, that a second wireless communication technology is being used on the wireless channel by another device based, at least in part, on a determination that the quantity of radio energy projections is above a detection threshold. The electronic device may transmit wireless traffic for the first wireless communication technology on the wireless channel, wherein the wireless traffic for the first wireless communication technology coexists on the wireless channel with coexisting signals of the second wireless communication technology on the wireless channel.

In some implementations, the electronic device may determine whether the second wireless communication technology is being used on the wireless channel by the other device without processing or decoding communication signals for the second wireless communication technology.

In some implementations, the electronic device may obtain measurements regarding the radio energy projections at periodic intervals. The electronic device may determine a total quantity of measurements that are above a signal strength threshold in a period of time. The electronic device may determine a first quantity of measurements that are attributable to the first wireless communication technology. The electronic device may determine a second quantity of measurements for a second wireless communication technology based, at least in part, on a difference between the first quantity of measurements and the total quantity of measurements. The second quantity of measurements may represent the quantity of the radio energy projections that are above the signal strength threshold and that are not attributable to the first wireless communication technology.

In some implementations, the first wireless interface may determine the second quantity of measurements for the second wireless communication technology by subtracting the first quantity of measurements from the total quantity of measurements. The first wireless device also may subtract a third quantity of measurements attributable to a third wireless communication technology that is implemented in a third wireless interface of the electronic device.

In some implementations, the first wireless interface may estimate an amount of utilization of the wireless channel that is attributable to the second wireless communication technology based, at least in part, on a magnitude of the second quantity of measurements. The amount of utilization may be proportional to the magnitude.

In some implementations, the first wireless interface may determine a pattern associated with the second quantity of the measurements. The first wireless interface may compare the pattern to a pattern profile that describes a communication format of the second wireless communication technology. The first wireless interface may identify the second wireless communication technology if the pattern matches the pattern profile.

In some implementations, comparing the pattern to the pattern profile may include comparing the pattern to a plurality of pattern profiles that describe communication formats of different wireless communication technologies.

In some implementations, the first wireless interface may compare the pattern to the pattern profile may include determining a time alignment between the pattern and the pattern profile. The first wireless interface may forecast future timing for at least part of a frame format of the second wireless communication technology based, at least in part, on the time alignment and the pattern profile.

In some implementations, the first wireless interface may transmit wireless traffic for the first wireless communication technology during time periods that avoid the future timing for at least part of the frame format of the second wireless communication technology.

In some implementations, the first wireless interface may be a wireless local area network (WLAN) interface associated with a WLAN communication technology, and the second wireless communication technology may be a wide area network (WAN) communication technology.

In some implementations, the WAN communication technology may be a long-term evolution (LTE) communication technology. The first wireless interface may determine a pattern associated with the quantity of the radio energy projections over a period of time. The first wireless interface may determine a time alignment between the pattern and a pattern profile that describes a communication format of the LTE communication technology. The first wireless interface may determine a periodic time period for a control channel of the LTE communication technology based, at least in part, on the time alignment and the pattern profile. The first wireless interface may refrain from transmitting wireless traffic for the first wireless communication technology during the periodic time period for the control channel of the LTE communication technology.

In some implementations, the first wireless interface may observe an energy roll-off following an instance of the periodic time period for the control channel of the LTE communication technology. The first wireless interface may determine a period of inactivity following the control channel based, at least, in part, on the pattern profile that describes the communication format of the LTE communication technology. The first wireless interface may transmit traffic for the WLAN communication technology during the period of inactivity.

Another innovative aspect of the subject matter described in this disclosure can be implemented as a method, system, computer-readable medium or other means in an electronic device. The electronic device may include a first wireless interface that is associated with a first wireless communication technology. The first wireless interface may obtain measurements regarding an amount of radio energy projections detected on a wireless channel at periodic intervals by the first wireless interface. For each measurement, the first wireless interface may provide the measurement to a pattern-matching unit of the electronic device if the measurement is above a signal strength threshold and if the measurement is not attributable to the first wireless communication technology. The pattern-matching unit may determine that a second wireless communication technology is being used on the wireless channel by another device based, at least in part, on a pattern in the measurements provided to the pattern-matching unit.

In some implementations, the first wireless interface may determine that the second wireless communication technology is being used on the wireless channel by the other device by comparing the pattern to a plurality of pattern profiles that describe communication formats of different wireless communication technologies. The first wireless interface may determine that the pattern matches a first pattern profile for the second wireless communication technology.

In some implementations, the first wireless interface may determine a time alignment between the pattern and the first pattern profile. The first wireless interface may determine a periodic time period for a control channel of the second wireless communication technology based, at least in part, on the time alignment and the first pattern profile. The first wireless interface may refrain from transmitting wireless traffic for the first wireless communication technology during the periodic time period for the control channel of the second wireless communication technology.

In some implementations, the first wireless interface may observe an energy roll-off following an instance of the periodic time period for the control channel of the second wireless communication technology. The first wireless interface may determine a period of inactivity following the control channel based, at least, in part, on the first pattern profile. The first wireless interface may transmit traffic for the first wireless communication technology during the period of inactivity.

In some implementations, the second wireless communication technology may be an LTE communication technology, and the period of inactivity may occur after a physical downlink control channel (PDCCH) in the first pattern profile.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a system diagram including a first wireless local area network (WLAN) device implementing a coexistence technique in accordance with some implementations of this disclosure.

FIG. 2 depicts components of a first wireless network interface capable of implementing a wireless coexistence technique in accordance with some implementations of this disclosure.

FIG. 3 shows a conceptual graph of measured radio energy and calculations for ascertaining the presence of a coexisting wide area network (WAN) communication technology.

FIG. 4 depicts an example frame format and transmission structure associated with a coexisting wireless communication technology.

FIG. 5 depicts a flowchart for determining whether a coexisting wireless technology is being used by other devices on a wireless channel based on a count of radio energy measurements.

FIG. 6 depicts a flowchart for determining whether a coexisting wireless technology is being used by other devices on a wireless channel based on a pattern of radio energy measurements.

FIG. 7 depicts a flowchart for filtering raw radio energy measurements to improve the accuracy of a count-based or pattern-matching determination of a coexisting wireless communication technology.

FIG. 8 shows a block diagram of an example electronic device for implementing aspects of this disclosure.

Like reference numbers and designations in the various drawings indicate like elements.

### DETAILED DESCRIPTION

A radio frequency band (such as 2.4 Ghz, 5 Ghz, or 6 Ghz frequency bands) may be concurrently used by different wireless technologies. Wireless transmissions by one system may cause radio energy projections that can impact another system. Some devices may implement a coexistence technique that enables concurrent use of a wireless communication medium. Traditionally, coexistence may have involved the use of collocated interfaces at a wireless device. For example, a collocated first interface may receive and process the coexisting wireless signals and provide coexistence data to a second interface at the wireless device via a local inter-interface link (which also may be referred to as an inter-interface connection or junction). The second interface may use the coexistence data to perform interference cancellation, spatial reuse, or cross-technology collision avoidance. While this design has been useful in legacy coexistence techniques, the design relies on collocated interfaces to generate local coexistence data, as well as inter-interface links between the collocated interfaces. The hardware requirements and processing capability may add cost or complexity to the design of a wireless device. It is desirable to detect coexisting signals even if the wireless device does not include the collocated interfaces or inter-interface links.

The description that follows includes example devices, methods, systems, instruction sequences and computer program products that implement techniques for wireless coexistence (which also may be referred to as over-the-air, OTA, coexistence detection). The wireless coexistence techniques can be used by a first wireless network interface (for a first wireless communication technology) for detection and characterization of coexisting communication signals of a second wireless communication technology (different from the first wireless communication technology). In some implementations, an electronic device can detect and characterize the coexisting communication signals without having a separate interface to receive and decode the coexisting communication signals.

In accordance with this disclosure, an electronic device can analyze radio energy measurements at a first wireless interface associated with a first wireless communication technology to infer the presence of signals associated with a different wireless communication technology utilizing the wireless channel. For example, an electronic device may utilize the first wireless interface associated with the first wireless communication technology to obtain measurements of radio energy on the wireless channel. The electronic device can analyze the measurements of radio energy projections detected on the wireless channel to determine whether another wireless communication technology is being used on the wireless channel by other devices. In one aspect, the electronic device does not need to decode the coexisting communication signals to determine time alignment for the other wireless communication technology. The electronic device may modify a transmission schedule for the first wireless communication technology based on the coexisting wireless communication technology.

In some implementations of this disclosure, the electronic device can maintain counters to aid in the analysis of the measurements of radio energy. The electronic device may obtain radio energy measurements at periodic intervals. One counter may count a total quantity of the measurements (such as C_{TOTAL}) that are above a signal strength threshold in a period of time. Another counter (or counters) may count a first quantity of the measurements (such as C_{WLAN}) that are attributable to the first wireless communication technology or to a locally coexisting wireless communication technology implemented at the electronic device. For example, the first quantity of the measurements may represent instances of measurements for which the electronic device positively knows the wireless communication technology. The electronic device may subtract the first quantity of measurements from the total quantity of measurements to determine a second quantity of measurements (such as C_{WAN}) representing a count of unidentified radio energy measurements above the signal strength threshold. If the second quantity of measurements are above a detection threshold, the electronic device may determine that a different wireless communication technology is being used on the wireless channel by other devices.

In some implementations of this disclosure, the electronic device may determine a pattern in the measurements of radio energy. For example, the electronic device may compare the timing or signal strength of radio energy measurements against an energy pattern associated with a different wireless communication technology. In some implementations, the electronic device may determine a time alignment between the radio energy measurements and a frame format for the different wireless communication technology. The electronic device may use the frame format and time alignment to characterize portions of the coexisting signals. For example, the electronic device may identify the timing of a control channel, periods of inactivity in the frame format, or other characteristics of the coexisting signals that can be considered when scheduling traffic for the first wireless communication technology.

Particular implementations of the subject matter described in this disclosure can be implemented to realize one or more of the following potential advantages. In one aspect, a first wireless interface can detect a coexisting wireless communication technology while reducing hardware design complexity. Because the coexistence techniques utilize radio energy measurements, the electronic device can determine potentially interfering signals from a different wireless communication technology even when the interfering signals are not directly on the wireless channel (such as harmonic frequency interference). Identifying the presence of a different wireless communication technology on the wireless channel may enable the electronic device to be a good neighbor to other devices that may be listening for communication signals of the different wireless communication technology. For example, the electronic device may refrain from transmitting over particular portions (such as control channel transmissions) of a frame format for the different wireless communication technology.

The examples in this disclosure are based on wireless local area network (WLAN) communication according to the Institute of Electrical and Electronics Engineers (IEEE) 802.11 wireless standards. For example, the first wireless interface is described as a WLAN interface. Typically, a WLAN interface is not configured to receive, demodulate, or decode other wireless communication technologies (such as wide area network, WAN, technologies). In accordance with an aspect of this disclosure, the WLAN interface may determine the presence of WAN signals (such as Long-Term Evolution, or LTE, signals) without separate hardware to receive and decode the WAN signal. The WLAN interface may schedule WLAN transmissions based on the timing of future WAN communications that may be predicted by the WLAN interface as a result of analyzing a pattern of radio projections for recently detected WAN communications. Although examples refer to particular WLAN or WAN wireless communication technologies, other types of wireless communication technologies can be used in other implementations of the described coexistence techniques. A person having ordinary skill in the art will readily recognize that the teachings herein can be applied in a multitude of different ways.

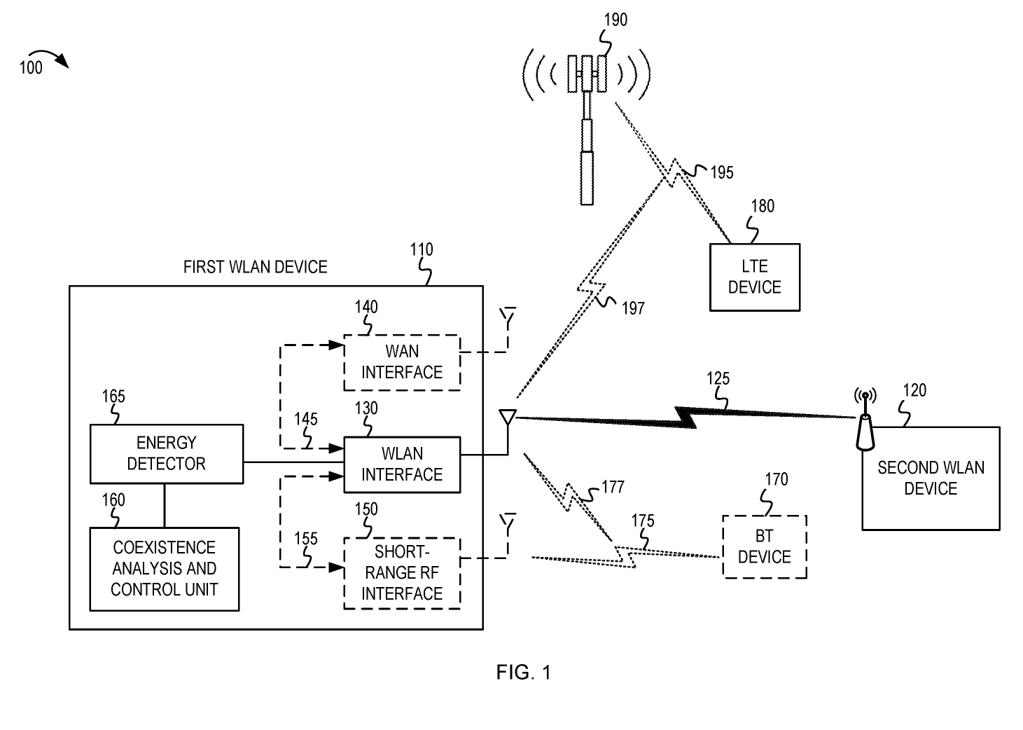

FIG. 1 depicts a system diagram including a first WLAN device operating in an area with coexisting wireless communication technologies. The system diagram 100 shows a first WLAN device 110 and a second WLAN device 120. The first WLAN device 110 may include a WLAN interface 130 configured to communicate using WLAN signals 125 associated with a first wireless communication technology (such as IEEE 802.11) to the second WLAN device 120. The first WLAN device 110 and the second WLAN device 120 may form a wireless network. In some implementations, one of the WLAN devices may operate as an access point (AP), and the other WLAN device may operate as a station (STA). In some implementations, the designation of AP and STA may be interchangeable, such as a peer-to-peer wireless communication technology. There may be other WLAN devices (not shown) in the wireless network. In some implementations, the first WLAN device 110 may be a multi-radio device. For example, the first WLAN device 110 also may include other interfaces, such as a WAN interface 140 or a short-range radio frequency (RF) interface 150. However, as described below, the first WLAN device 110 can detect coexisting wireless signals even when these other interfaces are not present in the first WLAN device 110.

The first WLAN device 110 may be operating in an area where different wireless communication technologies are in use. For example, the system diagram 100 shows a cellular base station 190 generating LTE signals 195 to an LTE device 180. The cellular base station 190 is one example of a WAN wireless communication technology which may utilize portions of a frequency range used by the WLAN devices 110, 120. Other wireless communication technologies (such as satellite communication, 5G, 6G, WiMax®, etc.) may utilize the frequency range and may create radio energy projections that are detectable by the WLAN interface 130. As shown in the system diagram 100, the LTE signals 195 may create energy projections 197 that can be detected by the WLAN interface 130. The first WLAN device 110 may attempt to minimize cross-technology interference between the LTE signals 195 and the WLAN signals 125. For example, it is desirable for the first WLAN device 110 to avoid creating interference for the WAN wireless communication technologies, and vice versa. In some implementations, it may be possible for the electronic device to select a different wireless channel to avoid the wireless channel used by a WAN wireless communication technology. However, channel reselection may not be possible. Coexistence techniques may be used so that both the WLAN communication signals and WAN communication signals can share the wireless channel.

Some legacy coexistence techniques make use of multiple receivers to detect different wireless signals. Each interface may receive and decode wireless communication signals for their respective interface type. For example, the WAN interface 140 may decode LTE signals 195. The first WLAN device 110 may have a first inter-interface link 145 between the WAN interface 140 and the WLAN interface 130. For example, the first inter-interface link 145 may enable the WAN interface 140 to provide local coexistence data to the WLAN interface 130. As shown in FIG. 1, the first WLAN device 110 also may have a short-range RF interface 150 that is communicating Bluetooth™ signals 175 to or from a Bluetooth device 170. The Bluetooth signals 175 may cause energy projections 177 that can be detected by the WLAN interface 130. If the first WLAN device 110 has a second inter-interface link 155, the second inter-interface link 155 may be used to provide local coexistence data from the short-range RF interface 150 to the WLAN interface 130. While this design has been useful in legacy coexistence techniques, the design relies on inter-interface links and collocated interfaces to generate local coexistence data. The hardware requirements and processing capability may add cost or complexity to the design of the first WLAN device 110. It is desirable to detect coexisting signals even if the first WLAN device 110 does not include the WAN interface 140, the short-range RF interface 150, or the inter-interface links 145, 155. For example, either the first WLAN device 110 may not have a local WAN interface 140 or may not have the first inter-interface link 145 between the local WAN interface 140 and the WLAN interface 130.

In accordance with this disclosure, the WLAN interface 130 may measure interference radio energy caused by energy projections 197 or 177. For example, without receiving the LTE signals 195, the WLAN interface 130 can still detect the energy projections 197 associated with the LTE signals 195. Similarly, the WLAN interface 130 can detect the energy projections 177 associated with the Bluetooth signals 175. Without decoding the LTE signals 195 or the Bluetooth signals 175, the WLAN interface 130 may analyze the energy projections 197, 177 to determine the presence of the coexisting signals over the air. In some implementations, the wireless coexistence detection technique can be combined with local coexistence data. For example, when the first WLAN device 110 includes the short-range RF interface 150 and the second inter-interface link 155 (but not the WAN interface 140 and the first inter-interface link 145), the WLAN interface 130 may avoid and disregard the energy projections 177 associated with the Bluetooth signals 175 based on the local coexistence data received via the second inter-interface link 155 from the short-range RF interface 150. The WLAN interface 130 may use the coexistence data from the short-range RF interface 150 to improve wireless coexistence detection of the energy projections 197 associated with the LTE signals 195. For brevity, the coexistence techniques are described with regard to the first WLAN device 110. However, in some implementations, the second WLAN device 120 also may implement the wireless coexistence detection. For example, both the first WLAN device 110 and the second WLAN device 120 may independently monitor the radio energy projections 197 to detect the presence of the LTE signals 195. Thus, they could avoid WLAN transmissions during time periods when the LTE signals 195 is active and minimize cross-technology interference.

In some implementations, the first WLAN device 110 may include an energy detector 165 and a coexistence analysis and control unit 160. The energy detector 165 may be configured to obtain measurements of radio energy via the WLAN interface 130. For example, the energy detector 165 may be configured to measure a raw energy level of the energy projections 197, 177 as well as any other signals detected by the WLAN interface 130. The energy detector 165 may pass the measurements of radio energy to the coexistence analysis and control unit 160. The coexistence analysis and control unit 160 may implement analysis, detection, and characterization of the energy measurements in accordance with the wireless coexistence techniques described in this disclosure. For example, the coexistence analysis and control unit 160 may utilize counts of measurements from the energy detector 165 to determine a total count of measurements (C_{TOTAL}) above a signal strength threshold. The coexistence analysis and control unit 160 may subtract counts (C_{WLAN}) that are associated with the WLAN signals 125. The remaining counts (C_{WAN}) are associated with energy projections that are unrecognized by the WLAN interface 130. Depending on the quantity and pattern of the energy projections, the coexistence analysis and control unit 160 may infer the presence of a WAN signal (such as the LTE signals 195).

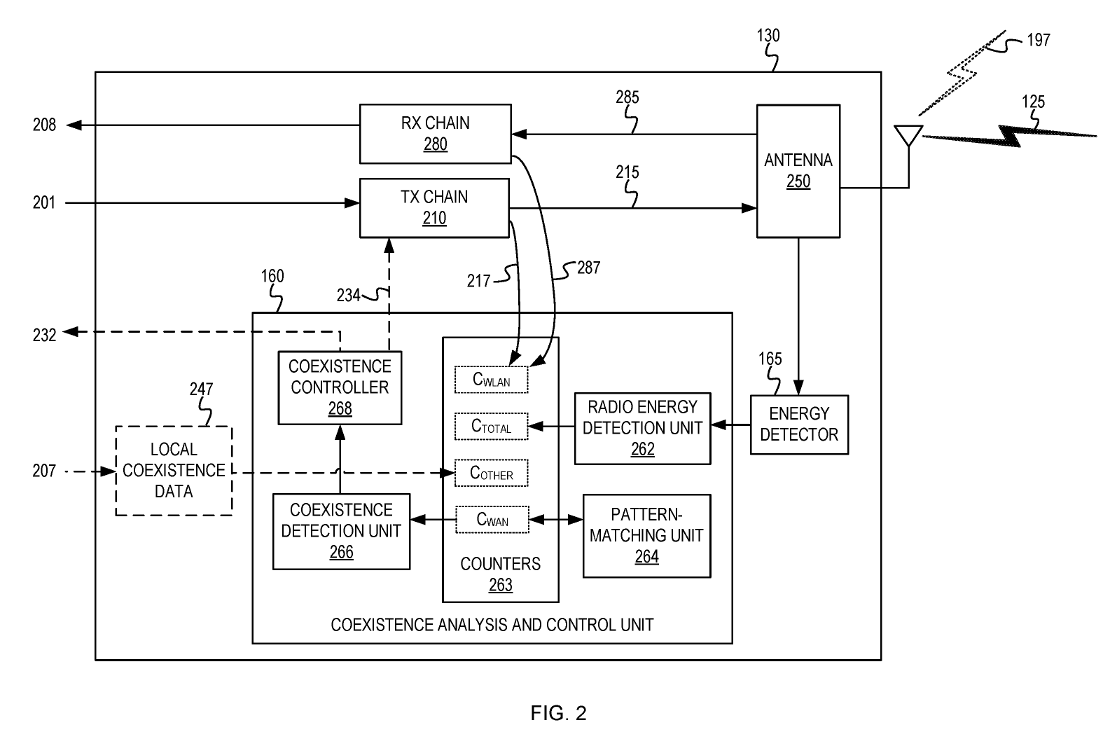

FIG. 2 depicts components of a first wireless network interface capable of implementing a wireless coexistence technique in accordance with at least some implementations of this disclosure. FIG. 2 shows a WLAN interface 130 similar to the WLAN interface described in FIG. 1. In some implementations, as shown in FIG. 2, the coexistence analysis and control unit 160 and the energy detector 165 may be integrated into the WLAN interface 130. The WLAN interface 130 includes an antenna 250 for sending and receiving WLAN signals 125. A transmit (TX) chain 210 is coupled (shown by arrow 215) to the antenna 250. The TX chain 210 may include components (not shown) for transmitting TX data 201 from an upper layer (not shown) of the electronic device. For example, the TX chain 210 may include a digital-to-analog converter, a modulator, filters, power amplifier, and other such components for preparing the TX data 201 for transmission via the antenna 250 as WLAN signals 125. When the WLAN interface 130 is receiving WLAN signals 125, the WLAN signals 125 may be coupled (shown by arrow 285) from the antenna 250 to a receive (RX) chain 280. The RX chain 280 may convert the WLAN signals 125 to receive data 208 to send to the upper layer of the electronic device. The RX chain 280 may include components (not shown) such as filters, amplifiers, converters, a demodulator, and the like.

The WLAN interface 130 may include an energy detector 165. In FIG. 2, the energy detector 165 is shown as a separate component of the WLAN interface 130 for illustration purposes. In some implementations, the energy detector 165 may be integrated into another component of the WLAN interface 130 (such as the RX chain 280) or may be outside the WLAN interface 130. The energy detector 165 may include components (not shown) to measure a raw energy level of signals (including the WLAN signals 125 and the energy projections 197). The energy detector 165 may pass the measurements of radio energy to a radio energy detection unit 262 of the coexistence analysis and control unit 160. The radio energy detection unit 262 may compare the measurements of radio energy to a signal strength threshold. If a measurement is above the signal strength threshold, the radio energy detection unit 262 may add to a counter for a total count of measurements (C_{TOTAL}) above the signal strength threshold. The coexistence analysis and control unit 160 may maintain counters 262 for the various counts described in this disclosure. The counters 263 may include a counter (C_{WLAN}) based on energy measurements that can be attributed to the RX chain 280 and the RX chain 210. For example, the C_{WLAN} may be incremented with WLAN traffic counts are received (shown as arrow 287) from the RX chain 280 and received (shown as arrow 217) from the TX chain 210. If the electronic device has a collocated wireless interface (not shown), such as a short-range RF interface (or any other local wireless interface implemented at the electronic device), the coexistence analysis and control unit 160 may receive local coexistence data 247 from an inter-interface link 207 to the collocated interface. The local coexistence data 247 may be attributed to a collocated wireless technology and used to determine another count (C_{OTHER}).

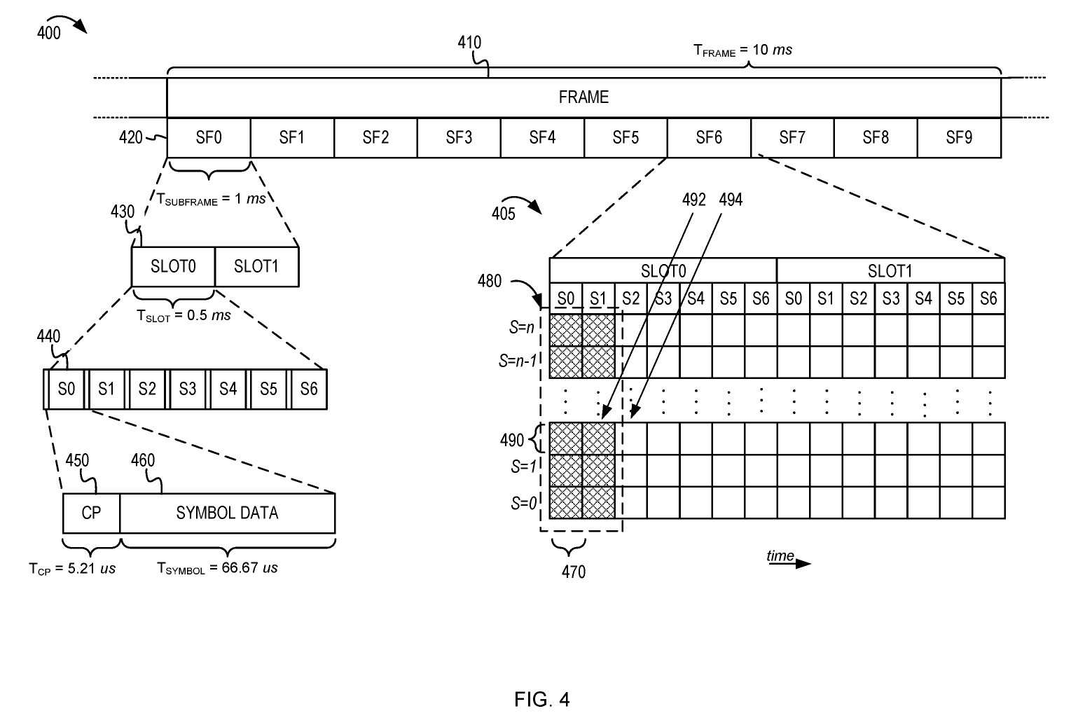

A coexistence detection unit 266 may use a calculation to determine how many of the counts (C_{WAN}) are attributed to a different wireless communication technology. (C_{WAN}=C_{TOTAL}−C_{WLAN}−C_{OTHER}). If the quantity of C_{WAN} is above a detection threshold, then the coexistence detection unit 266 may infer that there is a WAN communication technology in use in the area and that is creating energy projections in the frequency band used by the WLAN interface 130. In some implementations, after detecting the presence of the different wireless communication technology, the coexistence analysis and control unit 160 may implement a pattern matching unit 264 to identify a pattern associated with the WAN communication technology as described in the following figures. For example, the coexistence analysis and control unit 160 may include a pattern-matching unit 264 to identify which wireless communication technology is associated with the energy projections 197. The pattern-matching unit 264 may be configured to determine a frame format and time alignment for the coexisting wireless communication technology, as shown in FIG. 4.

After detecting the presence of the different wireless communication technology, the coexistence analysis and control unit 160 may have various ways to control the WLAN interface 130. For example, a coexistence controller 268 of the coexistence analysis and control unit 160 may send a signal (shown as arrow 234) to the TX chain 210 to cause the TX chain 210 to buffer or schedule transmit data during times when the coexisting wireless communication technology is utilizing the wireless channel. In another implementation, the coexistence controller 268 may send a signal (shown as arrow 232) to the upper layers of the electronic device to cause buffering or scheduling of the TX data 201 at the upper layers. Either of the signals (at arrows 232, 234) also may be used to prompt transmission during periods of inactivity in a frame format of the coexisting wireless communication technology. FIG. 4 provides an example scenario in which the coexistence analysis and control unit 160 can determine time alignment and certain time periods in a frame format of the coexisting wireless communication technology.

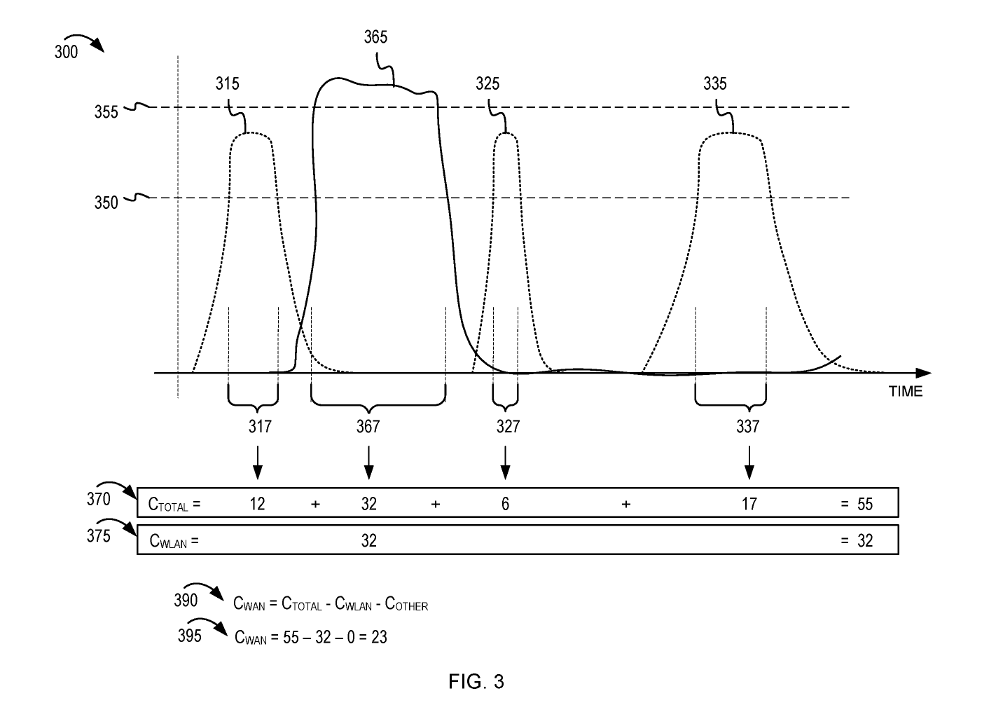

FIG. 3 shows a conceptual graph of measured radio energy and calculations for ascertaining the presence of a coexisting WAN communication technology. The graph 300 shows radio energy measured on a wireless channel over a time period. In the graph 300, a WLAN transmission 365 is shown along with unidentified radio energy projections 315, 325, 335. A WLAN interface of an electronic device may be capable of measuring radio energy on the wireless channel as part of a carrier sense (such as listen-before-talk) or enhanced collision avoidance technique. The WLAN interface may use this capability to periodically measure an amount of radio energy on the wireless channel. For example, the WLAN interface may measure an amount of raw radio energy every 1 μs. The WLAN interface may maintain a count of how many measurements indicate radio energy above a signal strength threshold 350. For example, the WLAN interface may count instances in which the raw energy contribution to the wireless channel is above X dBm (as an example, −62 dBm). This total count (C_{TOTAL}) may include raw energy transmissions from multiple contributors. As shown in FIG. 3, the unidentified radio energy projections 315, 325, 335 and the WLAN transmission 365 cause measurements during time periods 317, 327, 337 and 367, respectively, that are above the signal strength threshold 350. A calculation for a total quantity of measurements 370 above the signal strength threshold 350 is shown in FIG. 3. (C_{TOTAL}=12 counts associated with time period 317 plus 32 counts associated with time period 367 plus 6 counts associated with time period 327 plus 17 counts associated with time period 337.) The value of C_{TOTAL} is 55, which is a metric indicating a total quantity of measurements above the signal strength threshold 350.

The electronic device is configured to consider measurements that are attributable to WLAN traffic transmitted or received by the WLAN interface when performing a detection for a non-WLAN wireless communication technology. For example, the WLAN interface may maintain a WLAN counter for time periods which are associated with WLAN traffic. The WLAN counter may indicate a first quantity of measurements 375 which are known to be WLAN traffic. (C_{WLAN}=32 counts associated with time period 367). The WLAN counter may represent how much radio energy (in terms of airtime) the WLAN interface can attribute to WLAN communications.

In this example, FIG. 3 does not include Bluetooth traffic associated with a collocated short-range RF interface of the electronic device. However, if the electronic device has a collocated short-range RF interface, the electronic device could determine a quantity of measurements (POTHER) associated with communications sent or received by the short-range RF interface or other collocated interfaces in the electronic device (such as ZigBee®, ANT+®, WiMax®, WirelessHD, or the like). In FIG. 3, POTHER is zero because there are no collocated interfaces for this example.

The electronic device may subtract the quantity of measurements that are attributable to WLAN traffic and Bluetooth traffic from the total count to determine how many measurements may be associated with WAN traffic. FIG. 3 shows an example formula 390 (C_{WAN}=C_{TOTAL}−C_{WLAN}−C_{OTHER}) for determining a resulting count 395 (C_{WAN}=23) of measurements that may be associated with WAN traffic. The resulting count may be compared with a detection threshold to determine whether WAN traffic is present on the wireless channel. The detection threshold may be set to prevent false positives associated with occasional noise on the wireless channel.

As shown in FIG. 3, the duration of WAN traffic may not be consistent. In some implementations, a higher value of C_{WAN} may represent a higher volume of WAN traffic on the wireless channel, while a lower value of C_{WAN} may represent a lower volume of WAN traffic on the wireless channel. The magnitude of the value of C_{WAN} also may be used as a metric of confidence in the detection of the WAN signal.

There may be variations in how the counters are implemented. For example, in some implementations, the counters may operate while the WLAN interface continues to operate for sending or receiving WLAN signals. In some other implementations, the WLAN interface may pause normal operation and obtain a series of measurements of radio energy on the wireless channel over an observation time period.

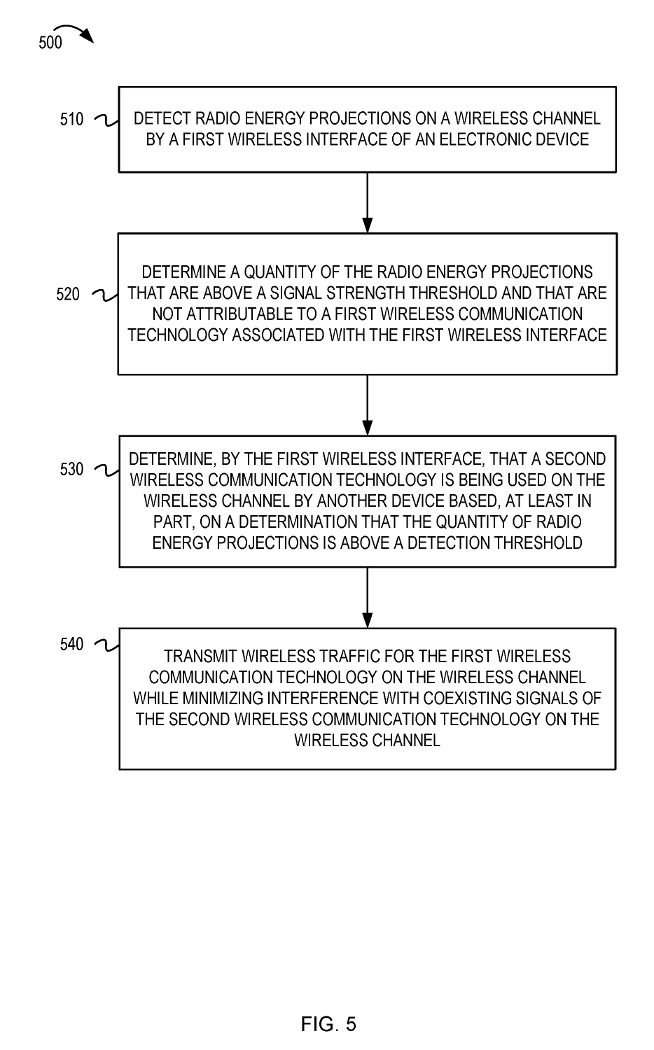

The use of counters described in FIG. 3 may provide a coarse approximation regarding the presence of WAN signals on the wireless channel. As shown further in FIG. 5, the measurements that are included in C_{WAN} may be further analyzed to determine a pattern in the measurements. When a pattern can be identified, the measurements may provide a more detailed estimate of timing for WAN communications on the wireless channel.

The example in FIG. 4 is based on a signal strength threshold 350 that is used by a WLAN interface for detection of energy projections. In some implementations, the signal strength threshold 350 may be different from a WLAN detection threshold 355. The WLAN detection threshold 355 may be used by the WLAN interface for a carrier sense (such as listen-before-talk) or enhanced collision avoidance technique for WLAN traffic. By using a signal strength threshold 350 that is lower than the WLAN detection threshold 355, the WLAN interface may have a greater sensitivity when detecting for potential WAN radio energy projections.

FIG. 4 depicts an example frame format and transmission structure associated with a coexisting wireless communication technology. A WLAN interface (or a pattern-matching unit of a coexistence analysis and control unit) may store pattern profiles for one or more potentially coexisting wireless communication technology. A pattern profile may be specific to a type of wireless communication technology and may be based a frame format and transmission structure for a specific wireless communication technology. The example frame format in FIG. 4 is based on an LTE frame format. LTE communication signals 400 may follow a technical specification defined for LTE. The implementation of the technical specification may include an LTE frame format 410 which causes energy projections in a deterministic pattern. For example, the LTE communication signals 400 are organized as a series of frames, such as LTE frame format 410. The LTE frame format 410 may be 10 ms in duration. The LTE frame format 410 is divided into 10 sub-frames (such as sub-frame 420) each of 1 ms in duration. Each sub-frame may include two slots (such as slot 430). Each slot is 0.5 ms in duration. In each slot, there may be 7 orthogonal frequency division multiplexed (OFDM) symbols (such as OFDM symbol 440). Each OFDM symbol may include a cyclic prefix 450 followed by symbol data 460. In FIG. 4, the cyclic prefix 450 is shown as having a 5.21 μs duration. However, in different configurations, the cyclic prefix 450 may have a different duration. The symbol data 460 has a duration of 66.67 μs.

In addition to the time domain frame format, the technical specification for LTE describes the OFDM symbols occupying resource blocks in the frequency domain. The technical specification may define the locations of certain logical channels within the frame format and resource block map. Together the frame format and resource block map may be referred to as a transmission structure for LTE. FIG. 4 shows part of a transmission structure for reference. A subcarrier map 405 shows the relationship between the time domain and the frequency domain. The illustrated subcarrier map 405 shows 14 symbols that make up one subframe (sub-frame 6) in the LTE frame format. Each OFDM symbol may be made of subcarriers. Each OFDM symbol may produce energy on each subcarrier 0 to n. One of the subcarriers 490 is identified in the transmission structure as an example.

The transmission structure may create a deterministic pattern that can be observed without decoding a received LTE frame format 410. For example, the first 2 OFDM symbols in each sub-frame may regularly include LTE signaling, such as control signaling. In other versions of LTE, there may be 3 OFDM symbols in each sub-frame that contains control signaling. Box 480 shows the control signaling in the first 2 OFDM symbols of a subframe of the transmission structure. The first 2 OFDM symbols of each subframe may form portions of a logical control channel in the transmission structure. For example, a physical downlink control channel (PDCCH) may occur in each subframe. The PDCCH may be a deterministic and timing precise occurrence in the LTE frame format (such the second OFDM symbol in each 1 ms subframe). Other patterns are observable, such as the primary synchronization channel (PSCH), secondary scheduling channel (SSCH), or the like. The PSCH and SSCH may be spread in 5 ms intervals within the transmission structure.

By observing energy measurements (without decoding the LTE frame format), a WLAN interface (such as a pattern-matching unit or a coexistence analysis and control unit 160) may be able to determine a time alignment between radio energy measurements attributed to the WAN signal and the transmission structure. The electronic device may store pattern profiles for different frame formats (or transmission structures) associated with different possible coexisting wireless communication technologies. If a pattern of radio energy measurements matches a pattern profile for the transmission structure, the WLAN interface may determine a time alignment of the LTE communication signals. For example, the WLAN interface may determine a timing of the PDCCH in the LTE communication signal without having to receive, demodulate or decode the LTE communication signal.

Furthermore, by observing energy projections in other OFDM symbols, the WLAN interface may determine the volume of user data being transmitted in the LTE wireless network. By observing the pattern of the measurements of radio energy for the WAN signal, the WLAN interface may determine periods of time available for WLAN communication signals during symbols or sub-frames in the LTE transmissions. For example, in a sub-frame of an LTE transmission, the first two symbols may include control channel data (PDCCH) and then roll off sharply if no user data follows the PDCCH. Once the WLAN interface determines the time alignment of the PDCCH (based on the pattern of radio energy measurements) in the LTE sub-frame, the WLAN interface can observe for a sharp roll off after ˜270 μs (the typical duration of the PDCCH transmissions in the sub-frame). The roll off may imply that no user data will occupy the remaining symbols of the subframe (approximately 700 μs). For example, in FIG. 4, arrow 492 points to a portion of the PDCCH in the second symbol of the subframe. If there is downlink user data to transmit, it will begin in the next symbol pointed by arrow 494. However, if there is no user data to transmit, the symbol pointed by arrow 494 may have a significantly lower amount of radio energy. During that unused portion of the subframe, the WLAN interface may transmit WLAN communication signals. The WLAN interface may refrain from transmitting during a time period associated with the PDCCH so that LTE devices can receive the PDCCH without interference from the WLAN interface.

Although the example in FIG. 4 describes LTE signals, other technologies could be identified based on matching patterns of raw energy with a specified frame format or transmission structure. For example, similar implementations could be used for wireless coexistence detection the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), AMPS, or other known signals that are used to communicate within a wireless, cellular or internet of things (IoT) network.

FIG. 5 depicts a flowchart for determining whether a coexisting wireless technology is being used by other devices on a wireless channel based on a count of radio energy measurements. The flowchart 500 begins at block 510.

At block 510, a first wireless interface of the electronic device may detect radio energy projections on a wireless channel by a first wireless interface of an electronic device. For example, the electronic device may obtain measurements regarding an amount of raw energy detected on a wireless channel at periodic intervals. The first wireless interface associated with a first wireless communication technology, such as WLAN. At block 520, the first wireless interface may determine a quantity of the radio energy projections that are above a signal strength threshold and that are not attributable to a first wireless communication technology associated with the first wireless interface. For example, the electronic device may determine a total quantity of measurements that are above a signal strength threshold in a period of time. The period of time may be a system- or user-configurable parameter. As described in FIG. 3, the signal strength threshold may be different from a pre-communication carrier sense threshold used by the first wireless interface.

At block 530, the first wireless interface may determine, by the first wireless interface, that a second wireless communication technology is being used on the wireless channel by another device based, at least in part, on a determination that the quantity of radio energy projections is above a detection threshold. For example, the electronic device may determine a first quantity of measurements that are attributable to the first wireless communication technology. For example, the first wireless interface may use counters from a receiver or transmitter in the first wireless interface to determine how much airtime is associated with the first wireless communication technology. The first wireless interface may determine a second quantity of measurements for a second wireless communication technology based, at least in part, on a difference between the first quantity of measurements and the total quantity of measurements. For example, the first wireless interface may subtract the first quantity of measurements from the total quantity of measurements to yield the second quantity of measurements. If the first wireless interface has an inter-interface link from another wireless interface at the electronic device, the first wireless interface may determine a third quantity of measurements based on coexistence data received via the inter-interface link. The first wireless interface also may subtract the third quantity of measurements from the total quantity of measurements. The resulting second quantity of measurements represents a metric of how many instances the first wireless interface detected unrecognized radio energy above a signal strength threshold. The first wireless interface may determine that the second wireless communication technology is being used on the wireless channel by other devices based, at least in part, on a determination that the second quantity of measurements is above a detection threshold. The detection threshold may be a system- or user-configurable parameter. If the first wireless interface determines that a second wireless communication technology is being used on the wireless channel by other devices, the first wireless interface may attempt to identify the second wireless communication technology based on analysis of the timing or pattern of measurements in the second quantity of measurements.

At block 540, the electronic device may transmit wireless traffic for the first wireless communication technology on the wireless channel while minimizing interference with coexisting signals of the second wireless communication technology on the wireless channel. For example, the electronic device may schedule wireless transmissions for the first wireless communication technology to occur during idle periods in the coexisting signals of the second wireless communication technology.

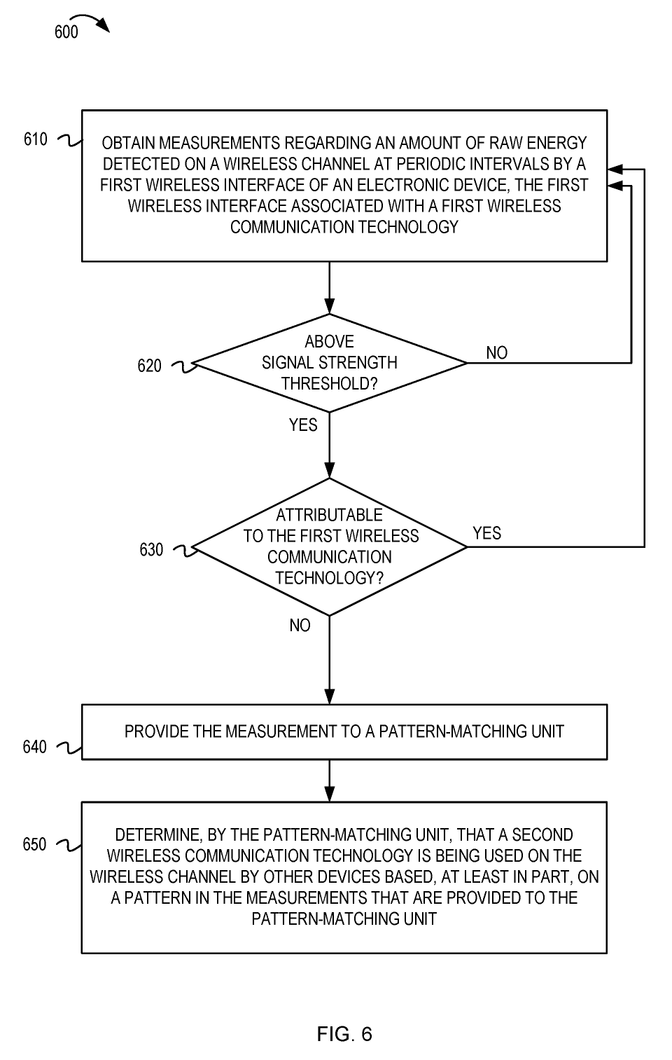

FIG. 6 depicts a flowchart for determining whether a coexisting wireless technology is being used by other devices on a wireless channel based on a pattern of radio energy measurements. The flowchart 600 begins at block 610.

At block 610, a first wireless interface of an electronic device may obtain measurements regarding an amount of raw energy detected on a wireless channel at periodic intervals. The first wireless interface associated with a first wireless communication technology. The periodic interval may be a fixed interval or a variable interval. For example, the periodic interval may be 1 μs.

For each measurement, the first wireless interface may use the measurement in a pattern-matching unit if the measurement matches criteria for potentially being related to a second wireless communication technology. For example, at decision 620, the first wireless interface may determine whether the measurement is above a signal strength threshold. If the measurement is not above the signal strength threshold, the measurement may be discarded (filtered) and the flowchart returns to block 610. If the measurement is above the signal strength threshold, the flowchart continues to decision 630 to qualify the measurement. At decision 630, the first wireless interface may determine whether the measurement is attributable to the first wireless communication technology. If the measurement is attributable to the first wireless communication technology, the measurement may be discarded, and the flowchart may return to block 610. If the measurement is not attributable to the first wireless communication technology, the flowchart continues to block 640. In some implementations, if the first wireless interface has an inter-interface link from another wireless interface at the electronic device, the first wireless interface may discard measurements that are attributable to the other wireless interface based on coexistence data based on coexistence data received via the inter-interface link.

At block 640, the first wireless interface may provide the measurement to the pattern-matching unit of the electronic device if the measurement matches the criteria for potentially being related to a second wireless communication technology. In some implementations, the pattern-matching unit may be implemented as a component of the first wireless interface (such as a coexistence analysis and control unit). In some other implementations, the pattern-matching unit may be implemented as instructions executed by a processor of the first wireless interface or in the electronic device.

At block 650, the pattern-matching unit may determine that a second wireless communication technology is being used on the wireless channel by other devices based, at least in part, on a pattern in the measurements provided to the pattern-matching unit. For example, the pattern-matching unit may match the pattern to a pattern profile representing a frame format of the second wireless communication technology. The pattern-matching unit may determine a time alignment with the frame format which can be used to determine future time periods of communication based on the frame format.

The above techniques may provide different levels of granularity for detecting and characterizing radio energy associated with a second wireless communication technology. The techniques may consider radio energy from unrecognized contributors to infer the presence and timing of communication signals for the second wireless communication technology. To improve the accuracy of these techniques, the first wireless interface may filter some radio energy measurements that can be determined as unrelated to the unrecognized contributors. For example, if there are WLAN collisions on the wireless channel, the WLAN collisions may generate radio energy captured in the measurements. However, if the WLAN interface is attempting to detect and characterize WAN signals, the measurements of radio energy generated by WLAN collisions may reduce the accuracy of the WAN detection.

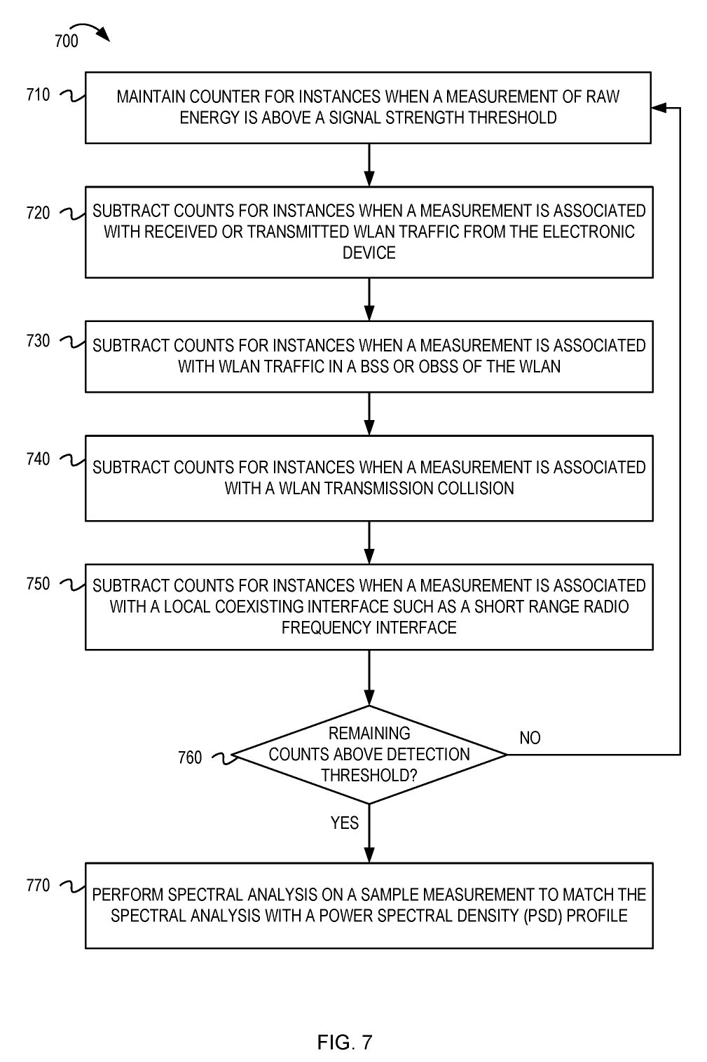

FIG. 7 depicts a flowchart for filtering raw radio energy measurements to improve the accuracy of a count-based or pattern-matching determination of a coexisting wireless communication technology. FIG. 7 describes two techniques for avoiding false detection that may result from collisions in the WLAN. The flowchart 700 begins at block 710. At block 710, a WLAN interface may maintain a counter for instances when a measurement of raw energy is above a signal strength threshold. This counter may be similar to C_{TOTAL} described previously in FIG. 3. At block 720, the WLAN interface may subtract (from C_{TOTAL}) counts for instances when a measurement is associated with received or transmitted WLAN traffic from the electronic device. For example, the WLAN interface may count time intervals during which it is transmitting or receiving WLAN frames. At block 730, the WLAN interface may subtract (from C_{TOTAL}) counts for instances when a measurement is associated with WLAN traffic in a basic service set (BSS) or overlapping BSS (OBSS) of the WLAN. For example, even if the WLAN interface is not directly communicating WLAN frames, the WLAN interface may maintain a counter when other devices in the WLAN are communicating. This number can be subtracted from C_{TOTAL} because it is related to WLAN traffic identifiable by the WLAN interface.

There may be instances when two or more WLAN devices attempt to communicate on the wireless channel and cause a collision. Typically the WLAN devices will back off and cease transmission until the next CS/ECA opportunity. However, the collisions may cause radio energy to be projected onto the wireless channel without the WLAN interface identifying it as associated with WLAN devices. If the WLAN interface is capable of detecting the collision, the WLAN interface may count measurements associated with WLAN collisions. If so, at block 740, the WLAN interface may subtract (from C_{TOTAL}) counts for instances when a measurement is associated with a WLAN transmission collision.

If the WLAN interface has a local inter-interface link from another wireless interface at the electronic device, the WLAN interval may receive local coexistence data that indicates when radio energy is contributed to the wireless channel by the other coexisting interface. At block 750, the WLAN interface may subtract (from C_{TOTAL}) counts for instances when a measurement is associated with a local coexisting interface such as a short-range radio frequency interface.

At decision 760, the WLAN interface may determine if the remaining counts (C_{WAN}=C_{TOTAL} minus the measurements from known contributors of radio energy) is above a detection threshold. If not, then the flowchart 700 may return to block 710. If the remaining count is above the detection threshold, then the WLAN interface may determine that WAN signals are present on the wireless channel. The flowchart 700 may continue to block 770.

At block 770, the WLAN interface may perform spectral analysis on a sample measurement to match the spectral analysis with a power spectral density (PSD) profile. For example, the WLAN interface may perform a spectral analysis using Fast Fourier Transform (FFT) on samples to see if the PSD of the samples matches a profile for a WLAN transmission or not. If the sample matches a profile for a WLAN transmission, then those instances of raw energy measurements would be subtracted from the counts so that they are not included in the C_{WAN} value. It is noted that the WLAN transmission performs the FFT to identify collisions of WLAN traffic that should not be attributed to potential WAN signals.

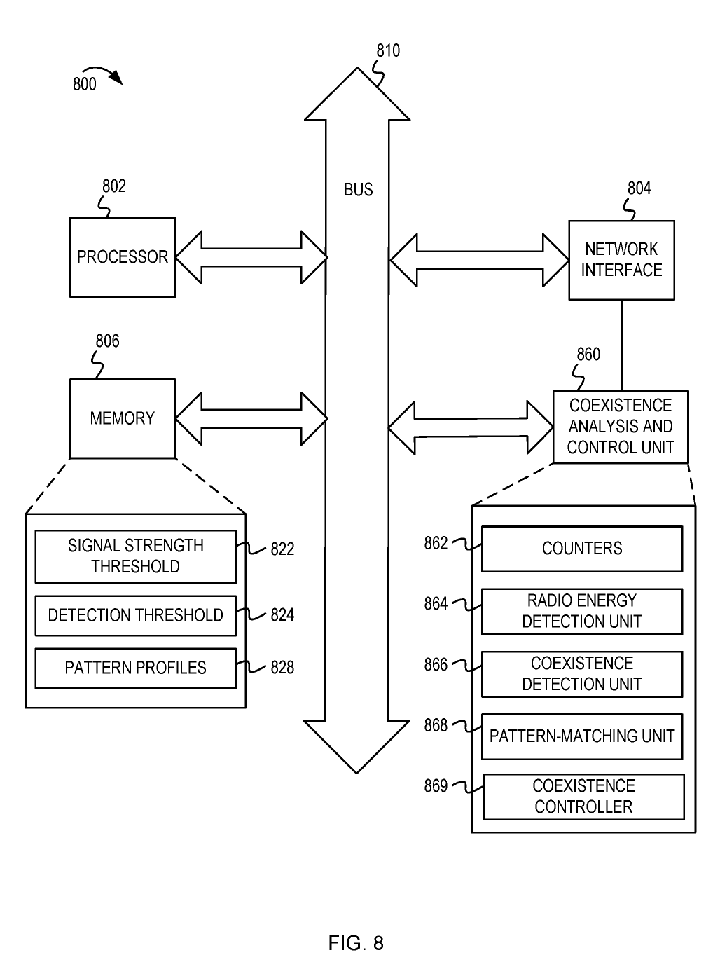

FIG. 8 shows a block diagram of an example electronic device for implementing aspects of this disclosure. In some implementations, the electronic device 800 may be one of an access point (including any of the APs described herein), a range extender, or other electronic systems. The electronic device 800 can include a processor unit 802 (possibly including multiple processors, multiple cores, multiple nodes, or implementing multi-threading, etc.). The electronic device 800 also can include a memory unit 806. The memory unit 806 may be system memory or any one or more of the possible realizations of computer-readable media described herein. The electronic device 800 also can include a bus 810 (such as PCI, ISA, PCI-Express, HyperTransport®, InfiniBand®, NuBus,® AHB, AXI, etc.), and a network interface 804 that can include at least one of a wireless network interface (such as a WLAN interface, a Bluetooth® interface, a WiMAX® interface, a ZigBee interface, a Wireless USB interface, etc.) and a wired network interface (such as an Ethernet interface, a powerline communication interface, etc.). In some implementations, the electronic device 800 may support multiple network interfaces—each of which is configured to couple the electronic device 800 to a different communication network.

The electronic device 800 may include a coexistence analysis and control unit 860. In some implementations, the coexistence analysis and control unit 860 can be distributed within the processor unit 802, the memory unit 806, and the bus 810. Although the coexistence analysis and control unit 860 is depicted separately from the network interface 804, in some implementations, the coexistence analysis and control unit 860 is implemented in the network interface 804. The coexistence analysis and control unit 860 can perform some or all of the operations described herein. For example, the coexistence analysis and control unit 860 may include counters 862, a radio energy detection unit 864, a coexistence detection unit 866, a pattern-matching unit 868, a coexistence controller 869, or the like. These units may be separate components or combined in various combinations in a processor and memory of the coexistence analysis and control unit 860. The memory 806 may store parameters used by the coexistence analysis and control unit 860. For example, the memory 806 may store a signal strength threshold 822, a detection threshold 824, pattern profiles 828 (templates for frame formats), and the like. Alternatively, these parameters may be stored in the coexistence analysis and control unit 860.

The memory unit 806 can include computer instructions executable by the processor unit 802 to implement the functionality of the implementations described in FIGS. 1-7. Any of these functionalities may be partially (or entirely) implemented in hardware or on the processor unit 802. For example, the functionality may be implemented with an application specific integrated circuit, in logic implemented in the processor unit 802, in a co-processor on a peripheral device or card, etc. Further, realizations may include fewer or additional components not illustrated in FIG. 8 (such as video cards, audio cards, additional network interfaces, peripheral devices, etc.). The processor unit 802, the memory unit 806, and the network interface 804 are coupled to the bus 810. Although illustrated as being coupled to the bus 810, the memory unit 806 may be coupled to the processor unit 802.

FIGS. 1-8 and the operations described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine-readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for wireless communication, comprising:
detecting radio energy projections on a wireless channel by a first wireless interface of an electronic device;
determining a quantity of the radio energy projections that are above a signal strength threshold and that are not attributable to a first wireless communication technology associated with the first wireless interface;
determining, by the first wireless interface, that a second wireless communication technology is being used on the wireless channel by another device based, at least in part, on a determination that the quantity of radio energy projections is above a detection threshold; and
transmitting wireless traffic for the first wireless communication technology on the wireless channel, wherein the wireless traffic for the first wireless communication technology coexists on the wireless channel with coexisting signals of the second wireless communication technology on the wireless channel.

2. The method of claim 1, wherein the electronic device can determine whether the second wireless communication technology is being used on the wireless channel by the other device without processing or decoding communication signals for the second wireless communication technology.

3. The method of claim 1, wherein determining the quantity of the radio energy projections that are above the signal strength threshold and that are not attributable to the first wireless communication technology includes:
obtaining measurements regarding the radio energy projections at periodic intervals;
determining a total quantity of measurements that are above the signal strength threshold in a period of time;
determining a first quantity of measurements that are attributable to the first wireless communication technology; and
determining a second quantity of measurements for a second wireless communication technology based, at least in part, on a difference between the first quantity of measurements and the total quantity of measurements, wherein the second quantity of measurements represents the quantity of the radio energy projections that are above the signal strength threshold and that are not attributable to the first wireless communication technology.

4. The method of claim 3, wherein determining the second quantity of measurements for the second wireless communication technology includes:
subtracting the first quantity of measurements from the total quantity of measurements; and
subtracting a third quantity of measurements attributable to a third wireless communication technology that is implemented in a third wireless interface collocated in the electronic device.

5. The method of claim 3, further comprising:
estimating an amount of utilization of the wireless channel that is attributable to the second wireless communication technology based, at least in part, on a magnitude of the second quantity of measurements, wherein the amount of utilization is proportional to the magnitude.

6. The method of claim 3, further comprising:
determining a pattern associated with the second quantity of the measurements;
comparing the pattern to a pattern profile that describes a communication format of the second wireless communication technology; and
identifying the second wireless communication technology if the pattern matches the pattern profile.

7. The method of claim 6, wherein comparing the pattern to the pattern profile includes comparing the pattern to a plurality of pattern profile that describe communication formats of different wireless communication technologies.

8. The method of claim 6, wherein comparing the pattern to the pattern profile includes determining a time alignment between the pattern and the pattern profile, the method further comprising:
forecasting future timing for at least part of a frame format of the second wireless communication technology based, at least in part, on the time alignment and the pattern profile.

9. The method of claim 8, further comprising:
transmitting wireless traffic for the first wireless communication technology during time periods that avoid the future timing for at least part of the frame format of the second wireless communication technology.

10. The method of claim 1, wherein the first wireless interface is a wireless local area network (WLAN) interface associated with a WLAN communication technology, and wherein the second wireless communication technology is a wide area network (WAN) communication technology.

11. The method of claim 10, wherein the WAN communication technology is a long-term evolution (LTE) communication technology, the method further comprising:
determining a pattern associated with the quantity of the radio energy projections over a period of time;
determining a time alignment between the pattern and a pattern profile that describes a communication format of the LTE communication technology;
determining a periodic time period for a control channel of the LTE communication technology based, at least in part, on the time alignment and the pattern profile; and
refraining from transmitting wireless traffic for the first wireless communication technology during the periodic time period for the control channel of the LTE communication technology.

12. The method of claim 11, further comprising:
observing an energy roll-off following an instance of the periodic time period for the control channel of the LTE communication technology;
determining a period of inactivity following the control channel based, at least, in part, on the pattern profile that describes the communication format of the LTE communication technology; and
transmitting traffic for the WLAN communication technology during the period of inactivity.

13. A method for wireless communication, comprising:
obtaining measurements regarding an amount of radio energy projections detected on a wireless channel at periodic intervals by a first wireless interface of an electronic device, the first wireless interface associated with a first wireless communication technology;
for each measurement, providing the measurement to a pattern-matching unit of the electronic device if the measurement is above a signal strength threshold and if the measurement is not attributable to the first wireless communication technology; and
determining, by the pattern-matching unit, that a second wireless communication technology is being used on the wireless channel by another device based, at least in part, on a pattern in the measurements provided to the pattern-matching unit.

14. The method of claim 13, wherein determining that the second wireless communication technology is being used on the wireless channel by the other device includes:
comparing the pattern to a plurality of pattern profiles that describe communication formats of different wireless communication technologies; and
determining that the pattern matches a first pattern profile for the second wireless communication technology.

15. The method of claim 14, further comprising:
determining a time alignment between the pattern and the first pattern profile;
determining a periodic time period for a control channel of the second wireless communication technology based, at least in part, on the time alignment and the first pattern profile; and
refraining from transmitting wireless traffic for the first wireless communication technology during the periodic time period for the control channel of the second wireless communication technology.

16. The method of claim 15, further comprising:
observing an energy roll-off following an instance of the periodic time period for the control channel of the second wireless communication technology;
determining a period of inactivity following the control channel based, at least, in part, on the first pattern profile; and
transmitting traffic for the first wireless communication technology during the period of inactivity.

17. The method of claim 16,
wherein the second wireless communication technology is an LTE communication technology, and
wherein the period of inactivity occurs after a physical downlink control channel (PDCCH) in the first pattern profile.

18. An electronic device, comprising:
a first wireless interface associated with a first wireless communication technology;
a processor; and
memory having instructions stored therein which, when executed by the processor, cause the electronic device to:
detect radio energy projections on a wireless channel by a first wireless interface of an electronic device;
determine a quantity of the radio energy projections that are above a signal strength threshold and that are not attributable to a first wireless communication technology associated with the first wireless interface; and
determine, by the first wireless interface, that a second wireless communication technology is being used on the wireless channel by another device based, at least in part, on a determination that the quantity of radio energy projections is above a detection threshold.

19. The electronic device of claim 18, wherein the instructions, when executed by the processor, further cause the electronic device to:
obtain measurements regarding the radio energy projections at periodic intervals;
determine a total quantity of measurements that are above the signal strength threshold in a period of time;
determine a first quantity of measurements that are attributable to the first wireless communication technology; and
determine a second quantity of measurements for a second wireless communication technology based, at least in part, on a difference between the first quantity of measurements and the total quantity of measurements, wherein the second quantity of measurements represents the quantity of the radio energy projections that are above the signal strength threshold and that are not attributable to the first wireless communication technology.

20. The electronic device of claim 19, wherein the instructions, when executed by the processor, further cause the electronic device to:
determine a pattern associated with the second quantity of the measurements;
compare the pattern to a pattern profile that describes a communication format of the second wireless communication technology; and
identify the second wireless communication technology if the pattern matches the pattern profile.

21. The electronic device of claim 20, wherein the instructions to compare the pattern to the pattern profile include instructions which, when executed by the processor, cause the electronic device to compare the pattern to a plurality of pattern profiles that describe communication formats of different wireless communication technologies.

22. The electronic device of claim 20, wherein the instructions, when executed by the processor, cause the electronic device to:
determine a time alignment between the pattern and the pattern profile, the method further comprising:
forecast future timing for at least part of a frame format of the second wireless communication technology based, at least in part, on the time alignment and the pattern profile.

23. The electronic device of claim 22, wherein the instructions, when executed by the processor, cause the electronic device to:
transmit wireless traffic for the first wireless communication technology during time periods that avoid the future timing for at least part of the frame format of the second wireless communication technology.

24. A computer-readable medium having instructions stored therein which, when executed by a processor of an electronic device, cause the electronic device to:
detect radio energy projections on a wireless channel by a first wireless interface of an electronic device;
determine a quantity of the radio energy projections that are above a signal strength threshold and that are not attributable to a first wireless communication technology associated with the first wireless interface; and
determine, by the first wireless interface, that a second wireless communication technology is being used on the wireless channel by another device based, at least in part, on a determination that the quantity of radio energy projections is above a detection threshold.

25. The computer-readable medium of claim 24, wherein the instructions, when executed by the processor, further cause the electronic device to:
obtain measurements regarding the radio energy projections at periodic intervals;
determine a total quantity of measurements that are above the signal strength threshold in a period of time;
determine a first quantity of measurements that are attributable to the first wireless communication technology; and
determine a second quantity of measurements for a second wireless communication technology based, at least in part, on a difference between the first quantity of measurements and the total quantity of measurements, wherein the second quantity of measurements represents the quantity of the radio energy projections that are above the signal strength threshold and that are not attributable to the first wireless communication technology.

26. The computer-readable medium of claim 25, wherein the instructions, when executed by the processor, further cause the electronic device to:
determine a pattern associated with the second quantity of the measurements;
compare the pattern to a pattern profile that describes a communication format of the second wireless communication technology; and
identify the second wireless communication technology if the pattern matches the pattern profile.

27. The computer-readable medium of claim 26, wherein the instructions to compare the pattern to the pattern profile include instructions which, when executed by the processor, cause the electronic device to compare the pattern to a plurality of pattern profiles that describe communication formats of different wireless communication technologies.

28. The computer-readable medium of claim 27, wherein the instructions, when executed by the processor, cause the electronic device to:
determine a time alignment between the pattern and the pattern profile; and
forecast future timing for at least part of a frame format of the second wireless communication technology based, at least in part, on the time alignment and the pattern profile.

29. The computer-readable medium of claim 28, wherein the instructions, when executed by the processor, cause the electronic device to:
transmit wireless traffic for the first wireless communication technology during time periods that avoid the future timing for at least part of the frame format of the second wireless communication technology.

30. The computer-readable medium of claim 25, wherein the first wireless interface is a wireless local area network (WLAN) interface associated with a WLAN communication technology, and wherein the second wireless communication technology is a wide area network (WAN) communication technology, and wherein the instructions, when executed by the processor, cause the electronic device to:
determine a pattern associated with the second quantity of the measurements;
determine a time alignment between the pattern and a pattern profile that describes a communication format of the WAN communication technology;
determine a periodic time period for a control channel of the WAN communication technology based, at least in part, on the time alignment and the pattern profile; and
refrain from transmitting wireless traffic for the first wireless communication technology during the periodic time period for the control channel of the WAN communication technology.
